(19) United States
(12) Patent Application Publication
(10) Pub. No.: US 2025/0233205 A1
(43) Pub. Date: Jul. 17, 2025

(54) Negative Electrode and Lithium-Ion Secondary Battery

(71) Applicant: TOYOTA JIDOSHA KABUSHIKI KAISHA, Toyota-shi Aichi-ken (JP)

(72) Inventor: Naoki OSADA, Toyota-shi Aichi-ken (JP)

(73) Assignee: TOYOTA JIDOSHA KABUSHIKI KAISHA, Toyota-shi Aichi-ken (JP)

(21) Appl. No.: 19/017,994

(22) Filed: Jan. 13, 2025

(30) Foreign Application Priority Data
Jan. 16, 2024 (JP) 2024-004405

(51) Int. Cl. H01M 10/0565; H01M 4/02; H01M 4/133; H01M 4/134; H01M 4/62; H01M 10/0525

(52) U.S. Cl. CPC H01M 10/0565; H01M 4/133; H01M 4/134; H01M 4/62; H01M 10/0525; H01M 2004/027; H01M 2300/0082; H01M 2300/0085

(57) ABSTRACT

A negative electrode includes: a negative electrode current collector; and a negative electrode active material layer, wherein the negative electrode active material layer includes a first active material, a second active material, and a gel electrolyte, the gel electrolyte includes a polymer and a conductive material, the negative electrode active material layer includes the gel electrolyte in a surrounding of the first active material, and a concentration of the gel electrolyte in the surrounding of the first active material is higher than a concentration of the gel electrolyte in a region of the negative electrode active material layer other than the surrounding of the first active material.

### CROSS REFERENCE TO RELATED APPLICATIONS

This nonprovisional application is based on Japanese Patent Application No. 2024-004405 filed on Jan. 16, 2024 with the Japan Patent Office, the entire contents of which are hereby incorporated by reference.

### BACKGROUND

### Field

The present disclosure relates to a negative electrode and a lithium-ion secondary battery.

### Description of the Background Art

Japanese Patent Laying-Open No. 2021-48106 discloses an active material for a secondary battery in which silicon, which is a negative electrode active material, is coated with polyethylene oxide, which is a polar polymer, to form a negative electrode composite material containing a conductive material, thereby having a sufficient capacity and desirable cycling performance.

### SUMMARY

The active material containing silicon is greatly expanded and contracted due to charging and discharging. Therefore, when the active material containing silicon is used as the negative electrode active material, the electrolyte solution flows due to expansion and contraction to cause deviation of the electrolyte solution in the electrode, thus presumably resulting in an increase in resistance.

In Japanese Patent Laying-Open No. 2021-48106, since silicon is coated with polyethylene oxide, the increase in resistance due to repeated charging and discharging is suppressed to some extent. On the other hand, since the negative electrode active material is coated with the polar polymer, ion conductivity is low. Therefore, there is room for improvement with regard to an increase in initial resistance.

An object of the present disclosure is to suppress an increase in initial resistance.
[1] A negative electrode comprising:
a negative electrode current collector; and
a negative electrode active material layer, wherein
the negative electrode active material layer includes a first active material, a second active material, and a gel electrolyte,
the gel electrolyte includes a polymer and a conductive material,
the negative electrode active material layer includes the gel electrolyte in a surrounding of the first active material, and
a concentration of the gel electrolyte in the surrounding of the first active material is higher than a concentration of the gel electrolyte in a region of the negative electrode active material layer other than the surrounding of the first active material.

Since the gel electrolyte having a small fluidity is disposed in the surrounding of the first active material that is greatly expanded and contracted due to charging and discharging, the deviation of the electrolyte solution due to expansion and contraction is suppressed, and as a result, an increase in resistance due to repeated charging and discharging is suppressed. In addition, since the gel electrolyte is used only in the surrounding of the first active material, suppression of an increase in initial resistance is also expected.
[2] The negative electrode according to [1], wherein the polymer is a poly(vinylidene difluoride-hexafluoropropylene) copolymer.
[3] The negative electrode according to [1] or [2], wherein a content ratio of the first active material in the negative electrode active material layer is 5 mass % or more and 20 mass % or less.
[4] A lithium-ion secondary battery comprising the negative electrode according to any one of [1] to [3].

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing an example of a negative electrode of the present embodiment.

FIG. 2 is a schematic view showing one example of the lithium-ion secondary battery of the present embodiment.

FIG. 3 is a graph showing initial battery resistances of the batteries of Nos. 1 to 3.

FIG. 4 is a graph showing the resistance increase ratio with respect to the number of cycles in the batteries of Nos. 1 to 3.

### DESCRIPTION OF THE EMBODIMENTS

Hereinafter, embodiments of the present disclosure (hereinafter, simply referred to as “the present embodiment”) and examples of the present disclosure (hereinafter, simply referred to as “the present example”) will be described. However, the present embodiment and the present example do not limit the technical scope of the present disclosure.

### <Negative Electrode>

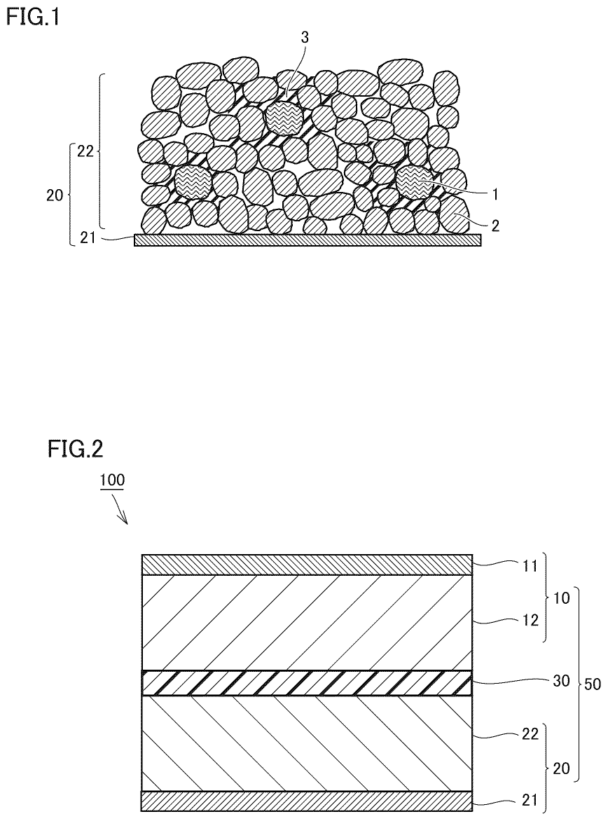

FIG. 1 is a schematic view showing an example of a negative electrode of the present embodiment. The negative electrode 20 includes a negative electrode current collector 21 and a negative electrode active material layer 22. The negative electrode current collector 21 may include, for example, a copper (Cu) foil, a nickel (Ni) foil, or the like.

### (Negative Electrode Active Material Layer)

The negative electrode active material layer 22 includes a first active material 1, a second active material 2, and a gel electrolyte 3. The gel electrolyte 3 includes a polymer and a conductive material. The negative electrode active material layer 22 includes a gel electrolyte 3 in the surrounding of the first active material 1. The concentration of the gel electrolyte 3 in the surrounding of the first active material 1 is higher than the concentration of the gel electrolyte 3 in the negative electrode active material layer 22.

The first active material 1 includes particles of a simple substance or oxide of the active material containing an element selected from the group consisting of silicon (Si), aluminum (Al), and tin (Sn). In some embodiments, the first active material 1 contains Si from the viewpoint of capacity, and examples thereof include Si simple substance, silicon oxide, and silicon carbide composite.

The content ratio of the first active material 1 in the negative electrode active material layer 22 is 5 mass % or more and 20 mass % or less.

In some embodiments, the average particle diameter (D50) of the first active material 1 is, for example, 3 μm or more and 20 μm or less, or 5 μm or more and 15 μm or less. In the present specification, the average particle diameter D50 is a particle diameter at which the accumulation of the frequency from the smaller particle diameter in the volume-based particle size distribution is 50%. The volume-based particle size distribution can be measured by a laser diffraction particle size distribution measuring apparatus.

The second active material 2 includes one or more particles selected from the group consisting of graphite, hard carbon, soft carbon, and carbon (C) such as amorphous coated graphite, or is one or more particles selected from the group. In some embodiments, the second active material 2 contains graphite, or consists of graphite. The graphite may be natural graphite or artificial graphite.

In some embodiments, the D50 of the second active material 2 is, for example, 5 μm or more and 15 μm or less, or 8 μm or more and 10 μm or less. In some embodiments, the D50 of the second active material 2 is smaller than the D50 of the first active material 1.

The content ratio of the second active material 2 in the negative electrode active material layer 22 is 75 mass % or more and 95 mass % or less.

The gel electrolyte 3 includes a polymer and a conductive material. The polymer functions as a gelling agent. The polymer may form a polymeric matrix. The polymer is not particularly limited as long as it functions as a gelling agent, and may be, for example, polyethylene carbonate (PEC), polyethylene oxide (PEO), polyvinylidene difluoride (PVdF), poly(vinylidene difluoride-hexafluoropropylene) copolymer (PVdF-HEP), polyacrylonitrile (PAN), PVdF-PAN, polyethylene glycol (PEG), and derivatives thereof. In some embodiments, the polymer comprises PVdF-HEP or consists of PVdF-HEP.

The content ratio of the polymer in the negative electrode active material layer 22 is 1 mass % or more and 5 mass % or less.

The conductive material forms a conductive path. Examples of the conductive material include carbon black (CB) (acetylene black (AB), Ketjen black (KB)), carbon nanotubes (CNT), and vapor-grown carbon fibers (VGCF).

The content ratio of the conductive material in the negative electrode active material layer 22 is 1 mass % or more and 5 mass % or less.

The gel electrolyte 3 includes an electrolyte solution. The electrolyte solution includes a solvent and a Li salt. The solvent is aprotic. The solvent may comprise any ingredient. The solvent may include, for example, at least one selected from the group consisting of ethylene carbonate (EC), dimethyl carbonate (DMC), and ethyl methyl carbonate (EMC).

The Li salt is a supporting electrolyte. The Li salt is dissolved in the solvent. The Li salt may contain, for example, at least one selected from the group consisting of LiPF₆, LiTFSI, and LiBF₄. The Li salt may have a molar concentration of, for example, 0.5 mol/L or more and 2.0 mol/L or less.

The electrolyte solution may further contain an optional additive. The electrolyte solution may contain, for example, 0.01 mass % or more and 5 mass % or less of an additive. The additive may include, for example, at least one selected from the group consisting of vinylene carbonate (VC), vinylethylene carbonate (VEC), and the like.

The negative electrode active material layer 22 includes a gel electrolyte 3 in the surrounding of the first active material 1. The concentration of the gel electrolyte 3 in the surrounding of the first active material 1 is higher than the concentration of the gel electrolyte 3 in a region of the negative electrode active material layer 22 other than the surrounding of the first active material 1. Since the gel electrolyte 3 having small fluidity is disposed in the surrounding of the first active material 1 that is greatly expanded and contracted due to charging and discharging, the deviation of the electrolyte solution due to expansion and contraction is suppressed, and as a result, an increase in resistance due to repeated charging and discharging is suppressed. In addition, since the gel electrolyte 3 is used only in the surrounding of the first active material 1, suppression of an increase in initial resistance is also expected.

Here, the expression “surrounding of the first active material 1” refers to a region within a circle having a radius of a certain distance from the center of gravity of the first active material 1, and typically refers to a region within a circle having a radius of a distance twice the average particle diameter of the first active material 1 from the center of gravity of the first active material 1. For example, the surrounding of the first active material 1 having an average particle diameter of 10 μm refers to a region within a circle having a radius of 20 μm from the center of gravity of the first active material 1.

The negative electrode active material layer 22 may further contain a binder, a thickener, or the like.

The binder may include, for example, PVdF, polytetrafluoroethylene (PTFE), styrene-butadiene rubber (SBR), or the like. The thickener may include, for example, carboxymethyl cellulose (CMC), methyl cellulose (MC), and the like.

The content ratio of the binder and the thickener contained in the negative electrode active material layer 22 is, for example, 0.1 mass % or more and 5 mass % or less.

In some embodiments, the supported amount of the active material in the negative electrode active material layer 22 is 20 mg/cm² or more. When the supported amount of the active material is 20 mg/cm² or more, improvement in cycling performance is expected. The “active material” includes both the first active material 1 and the second active material 2.

### <Method of Producing Negative Electrode>

The method of producing a negative electrode of the present embodiment includes at least (a) a precursor particle forming step, (b) a negative electrode active material precursor layer forming step, and (c) a negative electrode active material layer forming step.

### ((a) Precursor Particle Forming Step)

In the precursor particle forming step, the first active material, the second active material, the polymer, and the conductive material are mixed with a solvent and dried to form precursor particles. The precursor particle includes a polymer and a conductive material in the surrounding of the first active material, and further includes a second active material in the surrounding of the first active material.

For example, a mixture is prepared by dispersing the first active material, the polymer, and the conductive material in a solvent at a predetermined ratio and mixing and stirring them. The second active material is dispersed in the mixture at a predetermined ratio and mixed and stirred to prepare a first liquid coating material. The solvent is not particularly limited as long as it can disperse the first active material, the second active material, the polymer, and the conductive material, and examples thereof include N-methyl-2-pyrrolidone (NMP). Thereafter, the droplets are instantaneously dried by a method such as a spray drying method to obtain precursor particles. In this step, in some embodiments, the amount of the second active material added is smaller than the amount of the first active material added. This facilitates the formation of precursor particles. The addition amount of the second active material may be two times or more, three times or more, or four times or more the addition amount of the first active material. In this step, in some embodiments, the D50 of the second active material is smaller than the D50 of the first active material. This facilitates the formation of precursor particles.

### ((b) Negative Electrode Active Material Precursor Layer Forming Step)

In the negative electrode active material precursor layer forming step, the negative electrode active material precursor layer is formed by coating the negative electrode current collector with a second liquid coating material obtained by dispersing the precursor particles obtained in the precursor particle forming step and the second active material in a solvent.

For example, the second liquid coating material is prepared by dispersing the precursor particles and the second active material in a solvent (for example, water). In addition to the precursor particles and the second active material, a conductive material, a binder, a thickener, or the like may be mixed. The surface of the negative electrode current collector is coated with a second liquid coating material. For coating, for example, a doctor blade or a die coater is used. By drying the second liquid coating material, a negative electrode active material precursor layer is formed. After drying, the negative electrode active material precursor layer may be compressed.

### ((c) Negative Electrode Active Material Layer Forming Step)

In the negative electrode active material layer forming step, the negative electrode active material precursor layer obtained in the negative electrode active material precursor layer forming step is brought into contact with an electrolyte solution to form a negative electrode active material layer.

For example, when the negative electrode active material precursor layer is immersed in the electrolyte solution, the electrolyte solution permeates the precursor particles. The permeation of the electrolyte solution causes the polymer to swell. The negative electrode active material precursor layer may be immersed in an electrolyte solution under a temperature environment of, for example, 40° C. or more and 60° C. or less. The negative electrode active material precursor layer may be immersed in the electrolyte solution for, for example, 12 hours or more and 24 hours or less.

Note that this step may be one step of manufacturing a lithium-ion secondary battery. That is, after the negative electrode active material precursor layer forming step is finished, the lithium-ion secondary battery may be assembled, and an electrolyte solution may be injected into the lithium-ion secondary battery.

### <Lithium-Ion Secondary Battery>

FIG. 2 is a schematic view showing an example of a lithium-ion secondary battery (hereinafter, the battery is also simply referred to as a “battery”) of the present embodiment. The battery 100 may include an exterior package (not illustrated). The exterior package may contain the power generation element 50 and an electrolyte solution (not shown). The exterior package may have any form. The exterior package may be, for example, a metal case or a pouch made of a metal foil laminate film. The exterior package may contain, for example, Al or the like.

The battery 100 includes a power generation element 50. The power generation element 50 may also be referred to as an electrode assembly or an electrode group. The power generation element 50 includes a positive electrode 10, a separator 30, and a negative electrode 20. The power generation element 50 has any structure. For example, the power generation element 50 may be of a wound type. The positive electrode 10, the separator 30, and the negative electrode 20 may all be strip-shaped sheets. The power generation element 50 may be formed, for example, by stacking the positive electrode 10, the separator 30 (first sheet), the negative electrode 20, and the separator 30 (second sheet) in this order. After winding, the power generation element 50 may be formed into a flat shape.

### (Positive Electrode)

The positive electrode 10 may include a positive electrode current collector 11 and a positive electrode active material layer 12. The positive electrode current collector 11 may include, for example, an aluminum (Al) foil or the like. The positive electrode active material layer 12 contains a positive electrode active material. The positive electrode active material layer 12 may further contain, for example, a conductive material, a binder, or the like.

The positive electrode active material may be in the form of particles, for example. The positive electrode active material may have a D50 of, for example, 1 μm or more and 30 μm or less. The positive electrode active material may contain, for example, at least one selected from the group consisting of LiCoO₂, LiNiO₂, LiMnO₂, Li(NiCoMn)O₂, and Li(NiCoAl)O₂. For example, “(NiCoMn)” in “Li(NiCoMn)O₂” indicates that the total composition ratio in parentheses is 1. The amount of individual component is freely set as long as the total is 1.

The conductive material may include, for example, AB or the like. The binder may include, for example, PVdF. The conductive material and the binder may be, for example, 0.1 mass % or more and 10 mass % or less with respect to the positive electrode active material layer 12.

### (Separator)

The separator 30 is porous. The separator 30 can permeate the electrolyte solution. The separator 30 separates the positive electrode 10 from the negative electrode 20. The separator 30 is electrically insulating. The separator 30 may include, for example, a polyolefin resin such as polyethylene (PE) or polypropylene (PP). The separator 30 may have, for example, a single-layer structure or a multilayer structure. The separator 30 may be substantially composed of, for example, a PE layer, or may be formed by stacking a PP layer, a PE layer, and a PP layer in this order.

### (Electrolyte Solution)

The electrolyte solution includes a solvent and a Li salt. The solvent is aprotic. Aprotic solvents and Li salts are as described above.

The electrolyte solution may further contain an optional additive. The electrolyte solution may contain, for example, 0.01 mass % or more and 5 mass % or less of an additive. The additive may include, for example, at least one selected from the group consisting of vinylene carbonate (VC), vinylethylene carbonate (VEC), and the like.

### EXAMPLES

### (No. 1)

As materials of the negative electrode, Si (D50: 15 μm) (5 mass %) as a first active material, artificial graphite (D50: 6 μm) (86.5 mass %) as a second active material, SBR (4 mass %) as a binder, CMC (3 mass %) as a thickener, and AB (1.5 mass %) as a conductive material were prepared. These materials were mixed in distilled water and kneaded using a kneader to obtain a negative electrode paste.

The obtained negative electrode paste was applied to the surface of a Cu foil as a negative electrode current collector using a doctor blade. After the application, the negative electrode paste was dried at 100° C. for 15 minutes and compressed by a roll press machine to obtain a negative electrode of No. 1. The amount of the active material supported on the negative electrode active material layer was 20 mg/cm², the density of the negative electrode active material layer was 1.2 g/cm³ or more and 1.4 g/cm³ or less, and the same applies to the negative electrodes of Nos. 2 and 3 described later.

As materials of the positive electrode, LiNi_{0.6}Co_{0.2}Mn_{0.2}O₂ (95 mass %) as a positive electrode active material, AB (2.5 mass %) as a conductive material, and PVdF (2.5 mass %) as a binder were prepared. These materials were mixed with NMP and kneaded using a kneader to obtain a positive electrode paste.

The obtained positive electrode paste was applied to the surface of an Al foil as a positive electrode current collector using a doctor blade. After the application, the positive electrode paste was dried at 80° C. for 15 minutes and compressed by a roll press machine to obtain a positive electrode. The amount of the active material supported on the positive electrode active material layer was 38 mg/cm², and the density of the positive electrode active material layer was 3.2 g/cm³.

PE was prepared as a separator. The positive electrode and the negative electrode were alternately laminated with separators interposed therebetween to form a power generation element. The power generation element included four positive electrodes and five negative electrodes.

A pouch made of a laminate film was prepared as an exterior package. The power generation element was housed in the exterior package. As an electrolyte solution, a solution obtained by dissolving a supporting salt (LiPF₆) at a concentration of 1.2 mol/L in a mixed solvent containing EC, DMC, and EMC was prepared. The electrolyte solution was injected into the exterior package. After the electrolyte solution was injected, the exterior package was sealed under vacuum of −80 kPa. Thus, the battery No. 1 was produced.

### (No. 2)

Artificial graphite (86.5 mass %), Si (5 mass %), AB (1.5 mass %), PVdF (2 mass %) as a binder, and PVdF-HEP (5 mass %) as a polymer were prepared as materials of the negative electrode. A material other than PVdF-HEP was mixed with distilled water and kneaded using a kneader, and then PVdF-HEP was charged and further kneaded to obtain a negative electrode paste. Thereafter, a negative electrode of No. 2 was obtained in the same manner as in No. 1.

The same positive electrode, separator, exterior package, and electrolyte solution as in No. 1 were prepared. A power generation element was formed in the same manner as in No. 1. The power generation element was housed in the exterior package, and the electrolyte solution was injected into the exterior package. After the electrolyte solution was injected, it was held at 40° C. for 12 hours. Thereafter, the exterior package was sealed under vacuum of −80 kPa. Thus, the battery No. 2 was produced. In the battery of No. 2, the entire negative electrode active material layer was immersed in a gelled electrolyte solution (gel electrolyte).

### (No. 3)

As materials of the negative electrode, artificial graphite (15 mass %), Si (60 mass %), PVdF-HEP (20 mass %), and AB (5 mass %) were prepared. Si, PVdF-HEP, and AB were mixed with NMP and kneaded using a kneader. Then, artificial graphite was further added and kneaded to obtain a first paste. The obtained first paste was instantaneously dried by a spray dryer to obtain precursor particles.

Artificial graphite, SBR, CMC, and AB were prepared. These materials and the obtained precursor particles were mixed in distilled water and kneaded using a kneader to obtain a second paste. The content ratio (mass %) of each material in the second paste is artificial graphite: Si:AB:PVdF-HEP:SBR:CMC=86.5:5:1.5:1.7:2.65:2.65. Thereafter, a negative electrode of No. 3 was obtained in the same manner as in No. 1.

The same positive electrode, separator, exterior package, and electrolyte solution as in No. 1 were prepared. A power generation element was formed in the same manner as in No. 1. The power generation element was housed in the exterior package, and the electrolyte solution was injected into the exterior package. After the electrolyte solution was injected, it was held at 40° C. for 12 hours. Thereafter, the exterior package was sealed under vacuum of −80 kPa. Thus, a battery No. 3 was produced. In the battery of No. 3, a part of the negative electrode active material layer was immersed in a gelled electrolyte solution (gel electrolyte). That is, Si is surrounded by a gel electrolyte containing PVdF-HEP, and the concentration of the gel electrolyte in the surrounding of Si (Range within a circle whose radius is twice (30 μm) the average particle diameter of Si from the center of gravity of Si) is higher than the concentration of the gel electrolyte in a region other than the surrounding of Si.

### <Evaluation>

### (Battery Resistance)

The battery of each No. was allowed to stand still in a thermostatic chamber at 40° C. The battery was charged to 4.2 V at 0.5 C. The battery was discharged to 3.0 V at 0.5 C with a 10 minute pause. Note that “C” is a symbol indicating a time rate. The current of 1 C flows through the rated capacity of the battery in one hour.

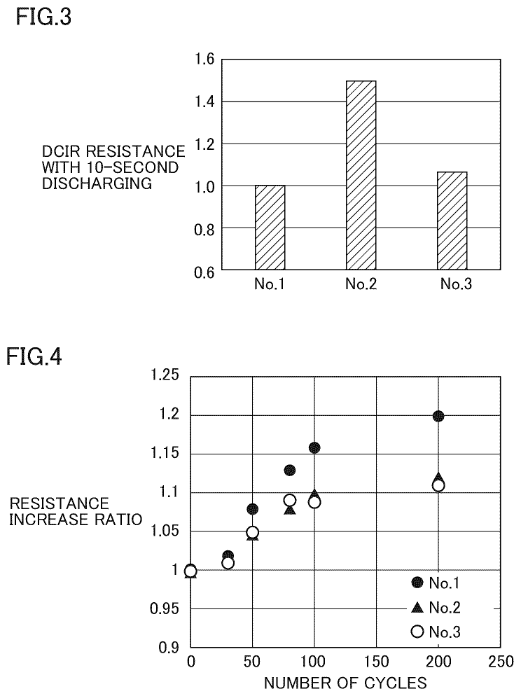

Next, the battery was sandwiched between two metal plates and restrained so that a load of 0.5 MPa was applied. This was allowed to stand in a thermostatic chamber at 25° C., and the battery was charged to 4.1 V. Thereafter, the battery was discharged for seconds at each of 0.5 C, 1 C, and 1.5 C. The initial DCIR (Direct Current Internal Resistance) of each No. battery was determined from the slope of the voltage change amount and the applied current. The results are shown in FIG. 3. The values in FIG. 3 are shown as relative values when the initial DCIR value of No. 1 is set to 1.

### (Resistance Increase Ratio)

The cycle of charging, stopping, and discharging was defined as one cycle, and 200 cycles of charging and discharging were performed in the battery of each No. The resistance increase ratio of each No. battery was determined by determining the DCIR of the battery after each cycle. The results are shown in FIG. 4. The values in FIG. 4 are shown as relative values when the initial DCIR value of each No. battery is set to 1.

### <Results>

As shown in FIG. 3, in No. 3, an increase in initial resistance is suppressed as compared with No. 2. Further, as shown in FIG. 4, it can be seen that the resistance increase ratio of No. 3 is reduced as compared with that of No. 1. From the above, it is considered that in No. 3, the increase in the initial resistance was suppressed, and the increase in the resistance increase ratio after the cycle test was also suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A negative electrode comprising:
a negative electrode current collector; and
a negative electrode active material layer, wherein
the negative electrode active material layer includes a first active material, a second active material, and a gel electrolyte,
the gel electrolyte includes a polymer and a conductive material,
the negative electrode active material layer includes the gel electrolyte in a surrounding of the first active material, and
a concentration of the gel electrolyte in the surrounding of the first active material is higher than a concentration of the gel electrolyte in a region of the negative electrode active material layer other than the surrounding of the first active material.

2. The negative electrode according to claim 1, wherein the polymer is a poly(vinylidene difluoride-hexafluoropropylene) copolymer.

3. The negative electrode according to claim 1, wherein a content ratio of the first active material in the negative electrode active material layer is 5 mass % or more and 20 mass % or less.

4. A lithium-ion secondary battery comprising the negative electrode according to claim 1.
